(19) United States
(12) Patent Application Publication
(10) Pub. No.: US 2009/0119581 A1
(43) Pub. Date: May 7, 2009

(54) METHOD AND APPARATUS FOR PROVIDING AUTO-COMPLETION OF INFORMATION USING STRINGS

(75) Inventor: Umashankar Velusamy, Tampa, FL (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 11/935,261

(22) Filed: Nov. 5, 2007

(51) Int. Cl. G06F 17/21; G06F 17/30

(52) U.S. Cl. 715/256; 707/102; 715/255; 707/E17.005; 707/E17.107

(57) ABSTRACT

An approach is provided for providing auto-completion of information functions utilizing strings. Textual input is received from a user via an application, an auto-complete variable (e.g., string) is retrieved based on the textual input, wherein the auto-complete variable includes a plurality of trigger strings from a predetermined number of matched data, the auto-complete variable is transmitted to the application, wherein the application compares the textual input with the auto-complete variable, an indication is received from the application that a match is found based on the comparison of the textual input and one of the trigger strings, information is retrieved in response to the indication, and the information is transmitted to the application for auto-completion of the textual input.

### BACKGROUND INFORMATION

The advent of global communication networks (e.g., the Internet) has served as a catalyst for the ubiquity of digital computing devices, as well as the inauguration of increasingly more data-centric applications, such as web-based entry forms and questionnaires including multiple input fields. In addition to enabling businesses, such as service providers, to collect vast amounts of consumer data, these applications also enable information to be efficiently stored and passed between one or more end-points. As such, when customers “sign up” for new services or participate in surveys “online,” service providers generally require consumers to repeatedly enter large quantities of information, such as mundane personal information, e.g., name, address, telephone number, etc. Generally, the amount of time taken by a customer to input this information is directly proportional the nature of the information being requested, and the accuracy with which a customer enters the data. Accordingly, data entry often becomes trite, and rather burdensome. It is not surprising then that the automated software industry is becoming a critical and ever growing market segment. Even still, advances in technology, services, and affordability can be better applied to foster the accuracy, interactivity, and speed with which automating software performs.

Therefore, there is a need for an approach that seamlessly provides robust techniques for efficient, automatic, and accurate completion of information.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing auto-completion of information, according to an exemplary embodiment;

FIGS. 2A and 2B are, respectively, a diagram of an application server employing auto-complete strings to provide auto-completion of information, and a diagram of the functional components of the system of FIG. 2A for auto-completion, according to various exemplary embodiments;

FIG. 3 is a flowchart of an auto-completion process performed at a user application, according to an exemplary embodiment;

FIG. 4 is a flowchart of a process for generating auto-complete strings to provide auto-completion of information, according to an exemplary embodiment;

FIG. 5 is a flowchart of an exemplary process for generating auto-complete strings for address information, according to an exemplary embodiment; and

FIG. 6 is a diagram of a computer system that can be used to implement various exemplary embodiments.

### DESCRIPTION OF THE PREFERRED EMBODIMENT

A preferred apparatus, method, and software for auto-completing information based on trigger strings are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although the various exemplary embodiments are described with respect to the use of strings, it is contemplated that these embodiments have applicability to other data types and data structures. These data types and data structures can include: primitive types/structures (e.g., characters, integers, floating-point numbers, fixed-point numbers, Booleans, etc.), composite types/structures (e.g., tuples, arrays, rational numbers, hash tables, storage records, object composition, etc.), abstract types/structures (e.g., associative arrays, complex numbers, containers, deques, lists, linked lists, multimapa, queues, priority queues, sets, stacks, trees, etc.), pointer/reference types/structures, algebraic types/structures, object types/structures, function types/structures, and the like, as well as combinations thereof.

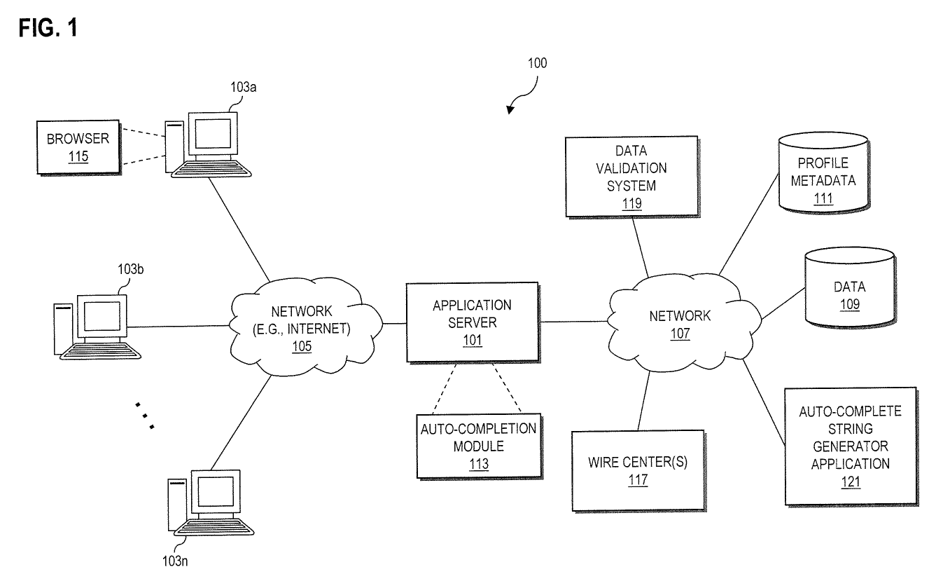

FIG. 1 is a diagram of a system capable of auto-completing information based on trigger strings, according to an exemplary embodiment. For the purposes of illustration, a system 100 is described with respect to a distributed client/server architecture of a service provider, such as a data, voice, and/or video carrier. While specific reference will be made thereto, it is to be appreciated that embodiments of system 100 may be provided having other computing architectures and/or environments (e.g., peer-to-peer).

It is noted that address validation is typically one of the first operations that businesses dealing with consumers perform. Within “online” environments, consumers and/or customer service representatives generally input addressing information into web-based applications, such as web-browsers. Conventional web-browsers, however, are generally made “thin,” i.e., typically focus primarily on conveying input and output between a user and a server. As such, entering information into these interfaces usually requires a user to manually input the entirety of an input parameter. New classes of web-browsers, including “rich” internet applications, may provide auto-complete functions; however, these applications generally require previous entries to be “remembered” before the auto-completion features are made available. In other instances, auto-completion functions may be provided via sequential queries to a database corresponding to sequential inputs to a browser application. While useful, these auto-completions are limited to previously acknowledged information, and therefore, are unavailable for “first-time” entries. Further, theses processes can significantly increase network traffic, not to mention enlarge processing loads. Thus, it is apparent that improvements are needed.

As shown, system 100 includes an application server 101 accessible to one or more client devices 103a-103n via, for example, network 105, e.g., the Internet. Application server 101 may access, as well as provide access to, one or more repositories of network 107, such as databases 109 and 111. In this manner, application server 101 includes an auto-completion module 113 configured to facilitate data entry in applications, such as browser application 115, executing on a client device, such as client device 103a. According to one embodiment, browser application 115 provides information gathering functions for (or related to) customer service procedures of a telecommunications service providers. For example, the information can relate to one or more wire centers 117. In particular implementations, system 100 includes a data validation system 119 configured to “validate” data entered into the applications of client devices 103a-103n. Namely, data validation system 119 ensures that data entered into the applications are correct (or comply with) one or more applicable standards, rules, and/or conventions of the particular data being handled. Certain embodiments of system 101 also provide an auto-complete variable (e.g, string) generator 121 for constructing “auto-complete variables” utilized by the applications of clients devices 103a-103n to determine when to query a database, e.g., database 109, for information to auto-complete (or provide auto-complete selections for) data entries within the applications. It is contemplated, however, that system 100 may embody many forms and include multiple and/or alternative components and facilities.

According to one embodiment, textual input fields are provided by browser application 115 for users (e.g., customers/customer service representatives) at client devices 103a-103n to enter data, i.e., textual information. Textual information may include any type of data related to the processes of application 115, but more specifically may include textual information, such as: demographic information (e.g., names, gender, race, occupation, etc.), addressing information (e.g., street, city, state, zip code, etc.), credentials information (e.g., social security numbers, credit card numbers, telephone numbers, user names, passwords, etc.), business information (e.g., wire center names, trouble ticket codes, purchasing data, medical data, recruitment data, etc.), and financial information (e.g., bank account numbers, routing numbers, etc.), as well as any other suitable textual input. As such, application server 101 is configured to receive textual input from a user to retrieve one or more “auto-completion strings” that provide client devices 103a-103n, e.g., browser application 115, with logic for determining when to query an associated database, e.g., database 109, for one or more auto-complete (or selectable auto-complete) data inputs. In this manner, the auto-complete functions of system 100 may be implemented even when the user is entering information for the “first-time.” That is, “auto-complete strings” may be particularly retrieved based on the input of a user, and implemented to predict when to retrieve information for auto-completion functions. Thus, certain embodiments of system 100 stem from the recognition that users can benefit from more flexible, robust methods of auto-completion that are driven based on the incremental input of the users, and operate so as to reduce the number of “keystrokes” (or other input means) the user must perform, as well as decrease the number of queries to a database for information to populate an auto-completion feature.

As seen in FIG. 1, components at, and included within, system 100 are connected to one or more networks (e.g., network 105 and/or network 107). These networks may include any type of network, such as, for example, a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. Networks 105 and 107 may employ various access technologies, such as: cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3 G wireless broadband networks, mobile television networks, radio networks, etc.), terrestrial broadcasting networks, provider specific networks (e.g., Verizon® FiOS® network), and the like. As such, networks 105 and 107 may utilize any suitable protocol supportive of data communications, e.g., transmission control protocols (TCP), internet protocols (IP), user datagram protocols (UDP), remote desktop protocol (RDP), hypertext markup languages (HTML), dynamic HTML (DHTML), simple object access protocol (SOAP), file transfer protocols (FTP), telnet, hypertext transfer protocols (HTTP), asynchronous transfer mode (ATM), wireless application protocols (WAP), socket connections (e.g., secure sockets layer (SSL)), Ethernet, frame relay, and the like, to logically connect the various components of system 100.

Accordingly, client devices 103a-103n, upon which various embodiments may be executed, can include, for example, any computing, telephony, or mobile apparatus capable of sending and/or receiving data. Computing devices may include desktop computers, notebook computers, servers, terminal workstations, console gaming systems, multi-processor systems, microprocessor-based or programmable consumer electronics, minicomputers, mainframe computers, customized hardware, or other equivalent apparatus. Telephony devices may comprise plain-old-telephones, wireless telephones, cellular telephones, satellite telephones, voice over internet protocol telephones, and the like. Mobile devices may include personal digital assistants (PDA), pocket personal computers, smart phones, tablets, handsets, portable gaming systems, pagers, and customized hardware, as well as any other suitable mobile technology. Moreover, client devices 103a-103n may be used alone or in combination with one another to implement various exemplary embodiments.

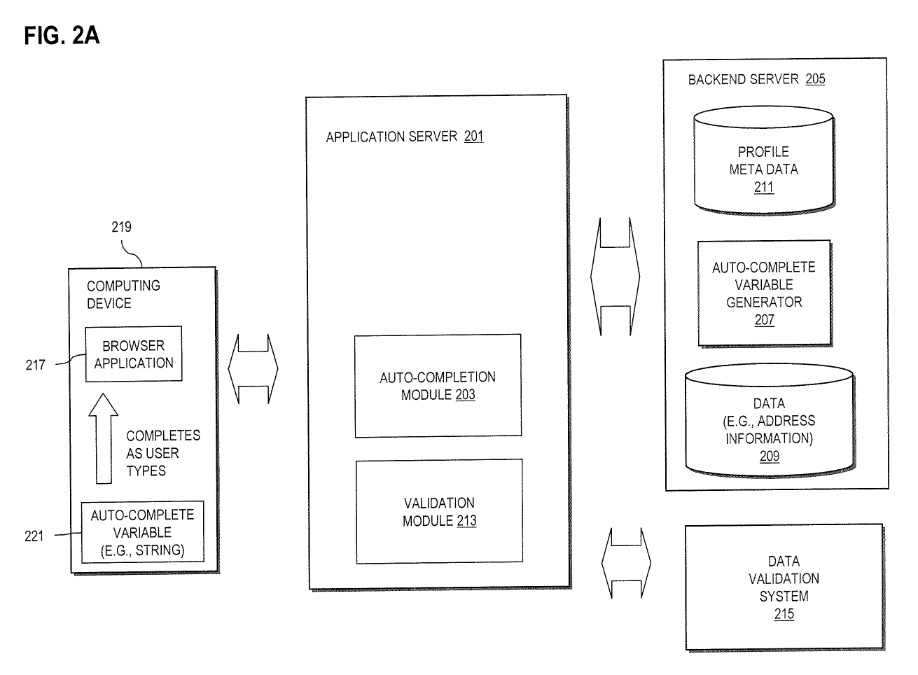

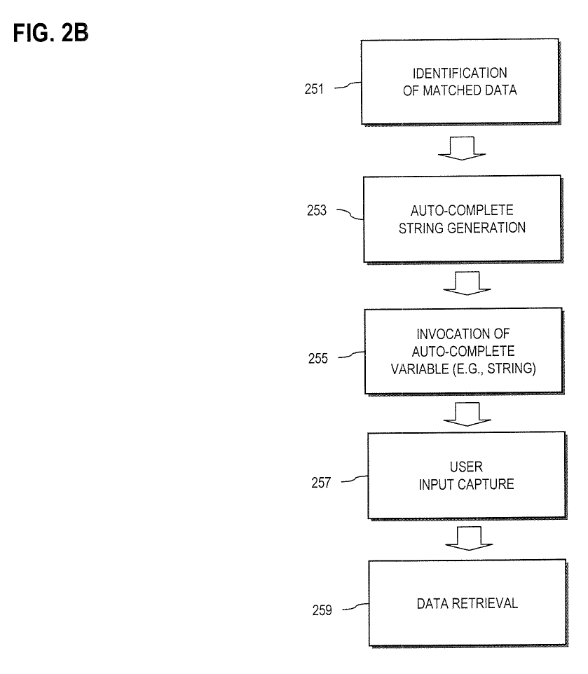

Databases 109 and 111 may be multi-dimensional, analytical processing, and/or any other suitable database for storing business intelligence, such as the informational forms previously delineated. As such, communication between database 109, database 111, application server 101 and/or auto-complete string generator 121, may be accomplished via one or more application programming interfaces (API) supporting one or more query languages, such as common query language (CQL), extensible markup language (XML) path language, object query language (OQL), and/or structured query language (SQL), as well as any other suitable language. According to one embodiment, data stored in (or to) database 109, database 111, and/or a memory (or other repository) of generator 121, is structured or compartmentalized into fields and tables, or any other suitable data structure, such as delimited text files. For example, addressing information may be stored to database 109 having a data structure including columns and rows corresponding to particular data fields and data entries, respectively. The data structure may be propagated with data entries corresponding to the addressing information for the purpose of forming scripts and/or auto-complete functions. It is noted that the aforementioned data structures are merely exemplary and are not intended to limit the nature or structure of databases 109 and 111, or storage locations of auto-complete string generator 121. The various components of addressing information are explained in more detail according to FIGS. 2A and 2B, which also further describe auto-complete string generator 121 and data validation system 119.

FIGS. 2A and 2B are, respectively, a diagram of an application server employing auto-complete strings to provide auto-completion of information, and a diagram of the functional components of the system of FIG. 2A for auto-completion, according to various exemplary embodiments. The auto-completion process can be applied to any data input requirement.

In the example of FIG. 2A, an application server 201 provides an auto-completion module 203 that communicates with a backend server 205 for obtaining auto-complete variables (e.g., strings). As such, the backend server 205 has an auto-complete string generator 207, which produces an auto-complete string based on data within a database 209. In addition, the backend server 205 employs a profile metadata database 211. These databases 209 and 211 can be separately provided—e.g., different memories or database systems; alternatively, the databases 209 and 211 can be a single standalone system.

For the purposes of illustration, the auto-completion module 203 operates to auto-complete address information. Accordingly, a profile within the profile metadata database 211 can contain information such as the number of streets present and/or information regarding the directional prefixes in the streets.

Address validation is an important function that organizations or companies that directly deal with customers perform. As shown, the application server 201 employs a validation module 213, which operates in conjunction with an external data validation system 215 to ensure accuracy of the input information. The address could be entered directly by a customer (such as in a website) or by a customer service representative, who would get the address from the customer and input the information into a software application. In either instance, however, these individuals may utilize a browser application, e.g., browser application 217, to input the information. This process can be time consuming, depending on the address itself, the communication between the representative and the customer, and the accuracy of the data entered. Table 1 enumerates exemplary address information.

TABLE 1

House Number Prefix
House Number
House Number Suffix
Street Directional Prefix
Street Name
Street Directional Suffix
Thoroughfare
City
State
Zip Code.

In this manner, an exemplary address may be provided as follows: 1 E Telecom Parkway SW, Temple Terrace, Fla.-33617. It is noted that the validation module 213, which perform address validation, might require the address to be input as individual address components listed above, or as a complete string, or as a combination of both address components and strings. To automate the address input process, part of the address may be obtained first and may be used to determine/predict the rest of the address, thereby reducing the number of keystrokes performed by the user (e.g., customer service representative), as well as the possibility of mismatches and/or typographical errors.

For example, a user may seek to enter the address, “1 E Telecom Parkway SW, Temple Terrace, Fla.-33617.” In this case, the user may be prompted by browser application 207 to input the zip code and/or city first. In the event there is only one city in the zip code, the user may not be prompted to enter the city name. In the event that there is more than one city associated to the zip code, the user may be prompted to choose one of the cities before proceeding. Once input, the street name “E Telecom Parkway SW” may be automatically completed if 33617+Temple Terrace has only one street: “E Telecom Parkway SW.” If, however, two streets exist, “E Telecom Parkway SW” and “W Telecom Parkway SW,” then the street name can be auto-completed as soon as the customer types “E” or “W,” or the streets may be provided within a drop list of selectable entries for the user to choose from. Accordingly, the process of data entry may be automated, even for “first time” entries.

Further, the address information categories of Table 1 may also be utilized for storage purposes. That is, the categories may be made to correspond to elements of a multidimensional, relational table of database 209, wherein actual address information is parsed into its individual components and stored according to one or more zip code and/or community (city name) combinations. The relational table may include one or more rows and/or columns, wherein individual rows may be utilized to correspond to complete address entries, while individual columns may be utilized to correspond to the various address information components. Such architecture enables application server 201, for instance, to efficiently acquire necessary information from database 209. It is contemplated, however, that any other storage scheme may be utilized, such as a hierarchical model, network model, etc., as well as combinations thereof.

According to one embodiment, a profile metadata can be built based on the data stored in database 209. That is, profile metadata can be structured and encoded to correspond to particular zip code and community (city name) combinations. The information built in the profile metadata may be utilized to assist with auto-completing the address input to an input field of an application (e.g., application 217) by the user. It is noted that metadata is generally considered data about data; but more specifically, metadata can be utilized to describe all aspects of, and data distributed through, system 100. In this manner, profile metadata provides a deeper understanding of the information, quality, and structure of the data as it resides in, for example, an underlying database. As such, profile metadata may be generated, and periodically updated, by a computing device, such as backend server 205. Namely, the actual data upon which profile metadata is constructed may be retrieved from database 209 and analyzed by a processor (not illustrated) of backend server 205 to structure and encode profile metadata. According to certain embodiments, profile metadata includes statistics and information about the underlying data which may be utilized to determine uses of the actual data, provide metrics on data quality, assess whether data may be integrated into an application, and create an enterprise view of the data, as well as any other suitable use. Thus, components of system 100 may utilize generated metadata for control, guiding, and/or data entry purposes, such as for auto-completion purposes.

In an exemplary embodiment, Table 2 provides the information built in the metadata profile for given community and zip code combinations:

TABLE 2

| | |
|---|---|
| 1. | Total Number of Streets |
| 2. | Total Number of Streets with Directional Prefix |
| 3. | Total Number of Streets with Directional Suffix |
| 4. | Total Number of Streets with Thoroughfare |
| 5. | Number of streets with the combinations of 2, 3, 4 and the |
| | numbers without the items discussed |
| 6. | Nature of the street number ranges |
| | (Odd/Even/Numeric/Alphanumeric) |
| 7. | Whether any of the streets have the same name as the |
| | directional prefixes |
| 8. | The actual elements, if the number is less |
| 9. | Alphabetical weightage on street names |

According to certain embodiments, the profile metadata information (e.g., total number of streets, and total number of streets with directional prefix) can be utilized in a variety of ways. In the case of the total number of streets, if a zip code/community combination has only one street, then the street can be completely auto-populated the moment the customer finalizes a community and zip code input. Namely, it will not be necessary to wait for the user to start typing the street name to populate a corresponding input field(s). Also, if a particular zip code and community combination includes a predetermined number of values (e.g., 10 streets), all the 10 streets may be displayed upfront for the user to select from, which can be provided even before the user begins to type anything. This may be accomplished via, for example, a drop down list of selectable entries.

As for the total number of streets with directional prefix, if none of the streets have directional prefixes, the recognition of the street name is simplified. In such case, it can be assumed that what the user inputs (e.g., types) is part of the street name. If there is only one directional prefix for the entire zip/community combination, then any textual input other than that directional prefix can be assumed to be a part of the street name.

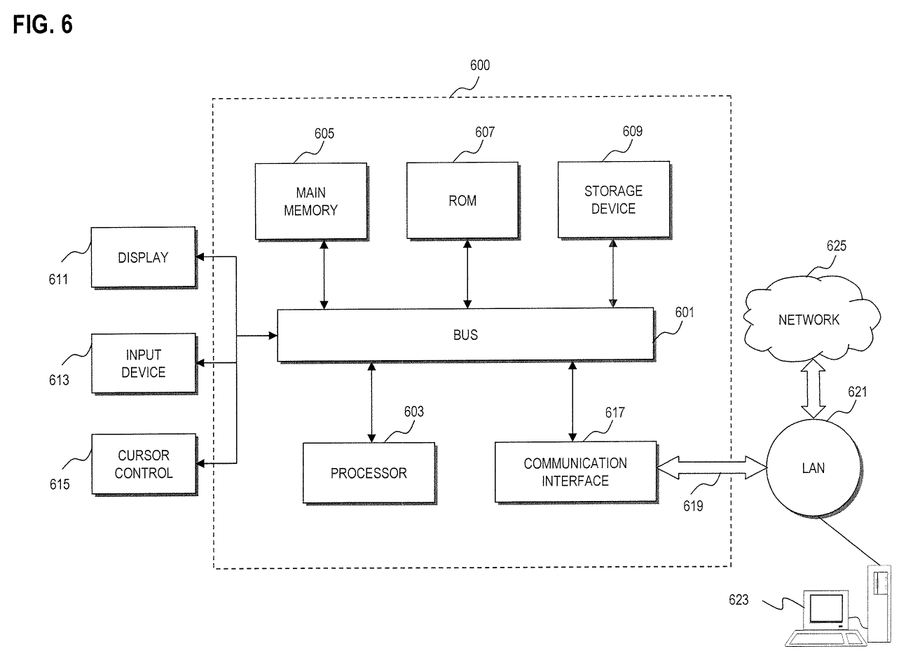

In this example, the browser application 217 resides within a computing device 219, which may include desktop computers, notebook computers, pocket personal computers, servers, terminal workstations, personal digital assistants (PDA), smart phones, tablets, handsets, gaming systems, customized hardware, or other equivalent apparatus, such as the computing hardware described with respect to FIG. 6.

The auto-completion capability, according to one embodiment, is largely based on the use of an auto-complete variable 221, which may be a string. For illustrative purposes, the auto-complete string 221 is described in the context of address information. It is noted that a street name is a string of characters, without any prefixes or street types such as “EAST” or “DRIVE.” For instance, “SMITH” may be an example of a street name, wherein a set of prefixes can be built from this street name. The set can be configured to include prefixes of the name; the string can be divided or parsed one character at a time, as shown in Table 3.

TABLE 3

S
SM
SMI
SMIT
SMITH

The set above can be referred to as a “list of sequential prefixes”—sequential because each prefix is constructed in order, starting at the first character and adding subsequent characters one at a time (“S”, “SM”, “SMI”, . . . ). This process is repeated for all of the streets in a zip/community combination to yield a list of prefixes. It is recognized that there can be numerous prefixes that are common to different street names. For example, if there were a street called “SMILE,” there would be three prefixes in common with SMITH: “S”, “SM”, and “SMI.”

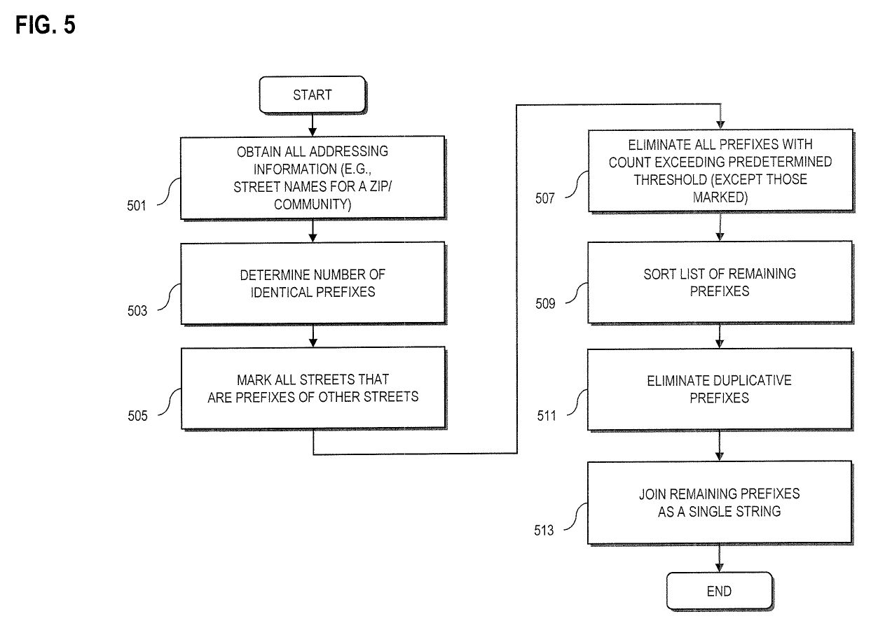

The auto-complete string generator 207 gathers together all the like prefixes and counts how many there are of the same type (that is, how many “S”, how many “SM”, and so on). These counts may be referred to as “occurrence counts,” and are used to narrow the potential list of streets. If, for example, there are 134 streets whose name begins with “SM,” but it is desired that the list of streets contain at most n (e.g., 10) names (n being predetermined threshold value), more characters would be required in a prefix set to reduce the number of potentially matching streets. This process is described in more detail with respect to FIG. 5.

FIG. 2B shows the functional components of the system of FIG. 2A for auto-completion using auto-complete strings. As shown, a module 251 provides identification of the total list of matches for a given criteria; this process can be performed off-line, in an exemplary embodiment, by for instance, backend server 205 or any other computing device having connectivity to network 107. The criteria can include a desired number of matches and limiting parameters, which define boundaries for the matches, such as a zip code, a city name, or a combination of a zip code and a city name.

An auto-complete string generation module 253 generates a comparison string comprising a series of trigger strings. Such string generation can also be executed off-line within the backend server 205, or other computing device having connectively to network 107. The generation module 253 takes a desired number of matches and a total list of strings, and then generates a series of trigger strings which when used, provides a predetermined number of results. These trigger strings are combined together via delimiters (such as a “|” character) to form a resultant string—i.e., an auto-complete string. In an exemplary embodiment, the generation of these strings are performed periodically. Details of this string generation process is more fully described with respect to FIG. 5.

Module 255 permits invocation of the auto-complete string, whereby the string is sent to browser application 217 along with any pertinent data, such as profile metadata and/or actual data corresponding to user input data. References to the script which can use the auto-complete/trigger strings for autocompletion can also be made.

User input is acquired by module 257, which captures and progressively compares a user's keystrokes to the one or more trigger strings of a given auto-complete string. For example, whenever a user starts to input data to application 217 implemented on client device 219, a limiting criteria may be obtained first, such as a zip code, followed by a query to obtain an auto-complete string corresoinding to that zip code before the user beings to type a street address, e.g., a street name, street number, etc. Along with the zip code, a metadata profile for the zip code containing relevant data, such as the number of streets with or without a street prefix, can also be provided to application 217. This information can assist with predicting user input and auto-completing a street address.

When a match is found, module 259 performs data retrieval by sending, for instance, a query to the backend server 205 to obtain matching lists of actual data stored within database 209. In other embodiments, matching lists may be generated during a query of database 209. Thus, when a user starts to input a parameter into an input field of application 217, application 217 may form a string with each character thus far input, and query for a trigger string match within the auto-complete string that was previously made available to application 217. For the purposes of illustration, the auto-complete string 221 is as follows (wherein “|” acts as the delimiter): “|SA|SC|SI|SK|SL|SN|SO|SP|SQ|SW|SY|SMA|SMIL|SMIT|SMIR|”. If, for instance, a user inputs “S” first, a query for a trigger string match of “|S|” is performed with respect to the received string. In this example, there are no matches. If the user inputs “M” next, a query for a trigger string match of “|SM|” is performed, also resulting in no matches. If the customer inputs “A” next, a trigger string match for “|SMA|” would result. In this instance, a query is sent to backend server 205 based on the “SMA” trigger string. The number of streets in the response to this query is designed to be within a predetermined threshold number of streets, or more simply stated, designed as a manageable quantity to be presented to and/or selected from by a user, via browser application 217.

The auto-complete string also helps to validate the user input and alert the user regarding any incorrect entries upfront, without having to verify with the backend (e.g., data validation system 215). For example, if the user has typed “SO” (and there are no matches starting with S), and there is no trigger string that matches “SO” either in whole or in part (SO/SOL/SON), then the backend would not have any entries that start with SA. It can be inferred that the user intended to type some other characters (e.g., SI—assuming it is valid), but typed SO instead. The string reduces the number of transactions that need to be exchanged with the backend to obtain necessary information for auto-completion, and also is useful in reducing the number of possible matches that need to be exchanged between the browser 217 and the backend 205.

In one embodiment, the auto-complete string 221 represents a collection of all the street name prefixes in a zip/community combination that yield a desired number of full street names when querying an associated database, such as database 209. For example, it may be desirable to restrict a drop-down list box in browser 217 to a certain number of entries, e.g., n=20. As such, a list of street name prefixes is produced such that the list returns no more than 20 street names that start with the associated prefix, such as “SMI.”

An exemplary auto-complete string 221 is as follows: |TY|VA|VE|VI|WE|WH|WO|WR|WY|ALA|ALB|ALD|ALE|ALF|ALI|ALL|ALM|ALP|BAH|BA L|BAN| . . . etc.

In this particular example, a threshold value is 9, and thus, there are no more than 9 unique street names in an associated zip/community combination that begin with, e.g., “ALB” or “BAN.” This string 221 is sent to browser application 217 and implemented by application 217 as a user inputs data to determine when to obtain (i.e., query for) the list of full street names from database 209.

In another example, a user of the browser application 217 lives on Banbury Street. Accordingly, the street name is “BANBURY” (ignoring case and thoroughfare). As the user inputs characters to browser application 217, the following Table (Table 5) illustrates exemplary results as each character is input.

TABLE 5

| | | | Matched Trigger |
|---|---|---|---|
| User Inputs | Input Thus Far | What is Searched | String |
| “B” | “B” | “\|B\|” | None |
| “A” | “BA” | “\|BA\|” | None |
| “N” | “BAN” | “\|BAN\|” | “\|BAN\|” - Complete |

Once a trigger string match is found (which can be performed using, for example, a JavaScript indexOf( )), a list of associated, complete street names can be retrieved from database 209.

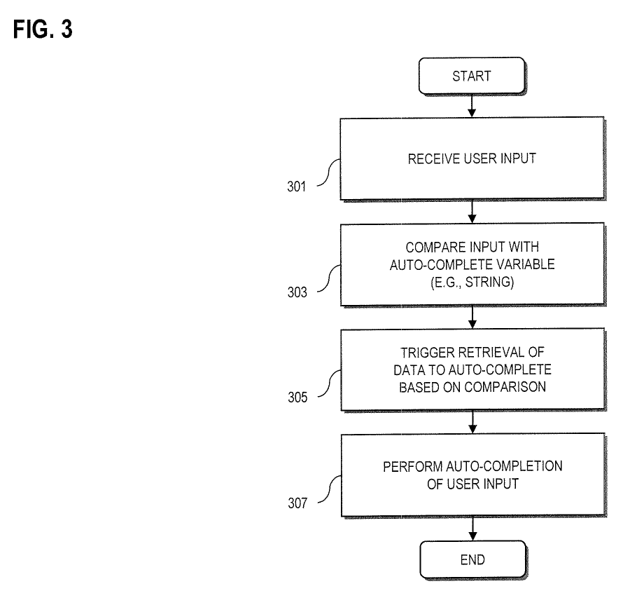

The operation of the auto-completion module 203 is further explained with respect to FIG. 3.

FIG. 3 is a flowchart of an auto-completion process performed at a user application, according to an exemplary embodiment. Initially, part of the information that the user inputs to browser application 217 is obtained, such as a zip code and/or city name combination. This information is then used to predict and auto-complete the remaining information, such as a street name. Continuing with the exemplary system of FIG. 2A, a user enters textual input (e.g., a zip code) to browser application 217 (step 301). At this point, the computing device 219 transmits the textual input to the auto-completion module 203 within the application server 201. Upon receipt of the user input, the auto-completion module 203 retrieves an auto-complete variable (e.g., string) from backend server 205. Additionally, the auto-completion module 203 may optionally access the profile metadata database 211 to retrieve a profile metadata or other data (e.g., actual data from database 209) corresponding to the textual input provided by the user. The auto-complete string 221 and any relevant data are transmitted to computing device 219, via application sever 201, i.e., auto-completion module 203.

In step 303, input of the user is compared with the auto-complete string. If the textual input corresponds to a trigger string within the auto-complete string, the computing device 219 retrieves associated data necessary to complete entry of the information, or provide a list of entries within a threshold value for user selection (steps 305 and 307).

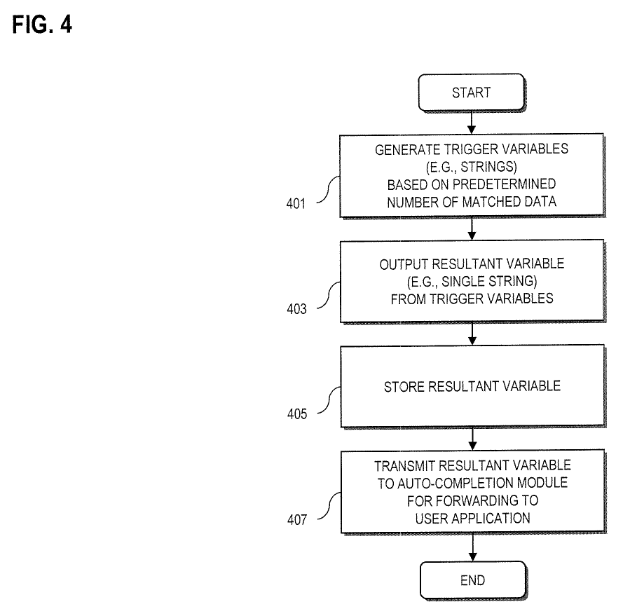

The process for constructing the auto-complete string by the backend server 205 is explained with respect to FIG. 4.

FIG. 4 is a flowchart of a process for generating auto-complete strings to provide auto-completion of information, according to an exemplary embodiment. In step 401, trigger variables (e.g., strings) are generated by the auto-complete string generator 207 based on a predetermined number of matched data. That is, a comparison is made between the trigger string and the occurrences of such strings within the data. In step 403, a resultant string is produced from the trigger strings. This resultant string is stored, as in step 405, and transmitted to the auto-completion module 203 for forwarding to browser application 217, per step 407.

It is noted that conventionally browsers have been provided with a mechanism to “remember” previous entries and auto-complete the same when the user tries to reenter the data. However, for this mechanism to operate, the user must have entered the data already and such data must have been stored locally in, for instance, a memory of an executing device. By contrast, the auto-completion module 203 provides auto-completion even when the user is inputting the data for the first time, i.e., no locally stored information, and does not require any information to be stored on the local computing device.

FIG. 5 is a flowchart of an exemplary process for generating auto-complete strings for address information, according to an exemplary embodiment. In step 501, all address information (e.g., street names for a zip/community) is obtained. Next, the address information is divided into segments, e.g., prefixes. For instance, each street name can be segmented into sets of prefixes (e.g., B, BA, BAN, etc.). In step 503, the number of identical prefixes is determined, resulting in a list of prefixes and their corresponding occurrence counts. Each item of the list can be a name/value pair, for example “BAN”, 9.

In step 505, the process marks all streets that are also prefixes of other streets; for example, if there is a street named “SEA”, and there is also a street names “SEAVIEW”, “SEA” is a prefix as well as “SEAVIEW.” Next, all prefixes whose count is greater than a configurable threshold (except for the ones marked in step 505) are eliminated, as in step 507. For example, if it is desirable to have the database search produce a list of at most 10 “unique” street names, all prefixes that have an occurrence count >10 are removed; “unique” in that if a street name also has directional prefixes like “E” and “W”, more than 1 street may be returned, such that the overall count may be greater than expected.

In step 509, the list of remaining prefixes is sorted alphabetically. Duplicates are eliminated, per step 511. The remaining prefixes are then join, per step 513, as a single string (separated by a special character (e.g., ‘|’) as a delimiter. It is noted that the string begins and ends with the separator.

The processes described herein for providing auto-completion of information may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below

FIG. 6 illustrates computing hardware (e.g., computer system) 600 upon which an embodiment according to the invention can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the invention has been described in connection with a number of embodiments and implementations, the invention is not so limited but covers various obvious modifications and equivalent arrangements.

What is claimed is:

1. A method comprising:
generating a plurality of trigger variables from a predetermined number of matched data;
outputting a resultant variable that includes the trigger variables; and
storing the resultant variable for retrieval by an application for auto-completing information corresponding to one of the trigger variables of the resultant variable.

2. A method according to claim 1, wherein the application is configured to receive textual input from a user, the method further comprising:
transmitting the resultant variable to the application in response to a user input that is provided to the application.

3. A method according to claim 2, further comprising:
transmitting the information in response to a match between the textual input and the one trigger variable.

4. A method according to claim 3, wherein the textual input includes addressing information.

5. A method according to claim 1, wherein the application is a browser application.

6. A method according to claim 1, wherein the textual input is provided to the application for a telecommunications service, and the information includes name of a wire center, the user being a customer representative or a subscriber.

7. A method according to claim 1, wherein the variables are strings.

8. An apparatus comprising:
a processor configured to generate a plurality of trigger variables from a predetermined number of matched data, and to output a resultant variable that includes the trigger variables; and
memory configured to store the resultant variable for retrieval by an application for auto-completing information corresponding to one of the trigger variables of the resultant variable.

9. An apparatus according to claim 8, wherein the application is configured to receive textual input from a user, the apparatus further comprising:
a communication interface configured to transmit the resultant variable to the application in response to a user input that is provided to the application.

10. An apparatus according to claim 9, wherein the communication interface is further configured to transmit the information in response to a match between the textual input and the one trigger variable.

11. An apparatus according to claim 10, wherein the textual input includes addressing information.

12. An apparatus according to claim 8, wherein the application is a browser application.

13. An apparatus according to claim 8, wherein the textual input is provided to the application for a telecommunications service, and the information includes name of a wire center, the user being a customer representative or a subscriber.

14. An apparatus according to claim 8, wherein the variables are strings.

15. A method comprising:
receiving a textual input from a user via an application;
retrieving an auto-complete variable based on the textual input, wherein the auto-complete variable includes a plurality of trigger variables from a predetermined number of matched data;
transmitting the auto-complete variable to the application, wherein the application compares the textual input with the auto-complete variable;
receiving an indication from the application that a match is found based on the comparison of the textual input and one of the trigger variables;
retrieving information in response to the indication; and
transmitting the information to the application for auto-completion of the textual input.

16. A method according to claim 15, further comprising:
receiving profile metadata along with the variable in response to the textual input, wherein the profile metadata is based on the textual input.

17. A method according to claim 16, wherein the profile metadata includes total number of streets, total number of streets with directional prefix, total number of streets with directional suffix, total number of streets with thoroughfare, nature of street number ranges, information specifying whether any of the streets have the same name as the directional prefixes, actual elements, alphabetical weightage on the street names, or a combination thereof.

18. A method according to claim 15, wherein the textual input includes a zip code, the method further comprising:
receiving another textual input including additional address information;
validating the other textual input; and
transmitting a validated address based on the validated textual input.

19. A method according to claim 15, wherein the application is a browser application.

20. A method according to claim 15, wherein the variables are strings.

21. A system comprising:
a first server configured to receive a textual input from a user via an application;
a second server configured to generate and store an auto-complete variable that includes a plurality of trigger variables from a predetermined number of matched data, wherein the first server retrieves the auto-complete variable from the second server based on the textual input, wherein the auto-complete variable includes a plurality of trigger variables from a predetermined number of matched data,
wherein the first server is further configured to transmit the auto-complete variable to the application, the application comparing the textual input with the auto-complete variable,
wherein the first server is further configured to receive an indication from the application that a match is found based on the comparison of the textual input and one of the trigger variables, to retrieve information from the second server in response to the indication, and to transmit the information to the application for auto-completion of the textual input.

22. A system according to claim 21, wherein the first server is further configured to receive profile metadata along with the variable in response to the textual input from the second server, wherein the profile metadata is based on the textual input.

23. A system according to claim 21, wherein the profile metadata includes total number of streets, total number of streets with directional prefix, total number of streets with directional suffix, total number of streets with thoroughfare, nature of street number ranges, information specifying whether any of the streets have the same name as the directional prefixes, actual elements, alphabetical weightage on the street names, or a combination thereof.

24. A system according to claim 21, wherein the textual input includes a zip code and the first server is further configured to receive another textual input including additional address information, the system further comprising:
a validation application configured to validate the other textual input, wherein the first server is further configured to transmit a validated address to the application based on the validated textual input.

25. A system according to claim 21, wherein the application is a browser application.
